(19) United States
(12) Patent Application Publication
(10) Pub. No.: US 2026/0098151 A1
(43) Pub. Date: Apr. 9, 2026

(54) THERMOPLASTIC COMPOSITION WITH OPTIMAL PROPERTY BALANCE

(71) Applicant: SABIC GLOBAL TECHNOLOGIES B.V., BERGEN OP ZOOM (NL)

(72) Inventor: Karin VAN DE WETERING, Bergen op Zoom (NL)

(21) Appl. No.: 19/113,106

(22) PCT Filed: Jul. 25, 2023
(86) PCT No.: PCT/EP2023/070619

§ 371 Date: Mar. 19, 2025

(30) Foreign Application Priority Data
Sep. 21, 2022 (EP) 22196857.1

(51) Int. Cl. C08L 69/00; C08L 67/06

(52) U.S. Cl. CPC C08L 69/00; C08L 67/06; C08L 2205/035

(57) ABSTRACT

The present invention relates to a thermoplastic composition comprising (A) aromatic polycarbonate, (B) polyethylene terephthalate, (C) poly(butylene terephthalate), (D) impact modifier, preferably (E) styrene acrylonitrile copolymer and optionally (F) additives. The thermoplastic composition according to the invention has improved balance between impact performance, flowability and stiffness. The present invention moreover relates to an article comprising the thermoplastic composition of the invention.

### CROSS-REFERENCE TO RELATED APPLICATIONS

This application is a National Stage application of PCT/EP2023/070619, filed Jul. 25, 2023, which claims the benefit of European Application No. 22196857.1, filed Sep. 21, 2022, both of which are incorporated by reference in their entirety herein.

### BACKGROUND

The present invention relates to a thermoplastic composition comprising (A) aromatic polycarbonate, (B) polyethylene terephthalate, (C) poly(butylene terephthalate), (D) impact modifier, preferably (E) styrene acrylonitrile copolymer and optionally (F) additives. The thermoplastic composition according to the invention has improved balance between impact performance, flowability and stiffness. The present invention further relates to an article comprising the thermoplastic composition.

Thermoplastic composition based on polycarbonate is known in the art, for example:
WO 2017/093232 discloses a thermoplastic composition comprising 0 to 50 weight percent of a polycarbonate, 10 to 50 weight percent of a polyester carbonate copolymer, 5 to 20 weight percent of a poly(ethylene terephthalate), 20 to 50 weight percent of a poly(butylene terephthalate), and optionally 5 to 30 weight percent of an impact modifier, wherein weight percent is based on the combined amounts of polycarbonate, polyester carbonate copolymer, poly(ethylene terephthalate), poly(butylene terephthalate) and optional impact modifier.
US 2008/0269399 discloses a composition comprising a polyester-polycarbonate polymer comprising isophthalate-terephthalate-resorcinol ester units and carbonate units, a first polyester selected from poly(ethylene-terephthalate), poly(ethylene-isophthalate), or a combination thereof, and a second polyester comprising butylene-terephthalate units, cyclohexanedimethylene terephthalate units, or a combination of cyclohexanedimethylene terephthalate units and ethylene terephthalate units. The polyester polycarbonate polymer in this reference is manufactured using an interfacial process.

However, for demanding applications, e.g., an automotive exterior trim part, there is still a need of a thermoplastic composition with improved balance between impact performance, flowability and stiffness. Improved low temperature impact is especially desired.

### SUMMARY

It was found this need is met, at least in part, in accordance with the present invention which is directed at a thermoplastic composition comprising:
(A) from 30 to 59 wt. % aromatic polycarbonate, wherein the aromatic polycarbonate has a weight average molecular weight in the range from 14.0 to 45.6 kg/mol as measured with gel permeation chromatography (GPC) using polystyrene standard;
(B) from 20 to 40 wt. % polyethylene terephthalate, wherein the polyethylene terephthalate has an intrinsic viscosity in the range from 0.50 to 1.21 dl/g as measured according to ASTM D2857-95 (2007);
(C) from 2 to 25 wt. % poly(butylene terephthalate), wherein the poly(butylene terephthalate) has a weight average molecular weight in the range from 45.0 to 150.0 kg/mol as measured with gel permeation chromatography (GPC) using polystyrene standard;
(D) from 10 to 20 wt. % impact modifier having a fraction in the range, wherein the impact modifier is selected from the group consisting of acrylonitrile styrene butadiene copolymer, ethylene acrylate copolymer, ethylene acrylate glycidyl copolymer and mixtures thereof;
wherein wt. % is based on the total weight of the thermoplastic composition.

It was found the thermoplastic composition shows improvement on impact performance without much compromise on the flowability and stiffness. In the context of the present invention, the impact performance is quantified by notch Izod measurement (ISO180/1A at 23, 0 and −10° C.); the flowability is quantified by Spiral flow measurement (ASTM D-3123 09 (2017) at 3 mm thickness) and stiffness is quantified by tensile modulus (ISO 527).

### DETAILED DESCRIPTION

### (A) Aromatic Polycarbonate

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect it is noted that in particular the so called “melt polycarbonate” typically has a minimum amount of Fries branching, which is generally absent in “interfacial polycarbonate”. Apart from that melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups.

In accordance with the invention, it is preferred that the aromatic polycarbonate comprises or consists of bisphenol A polycarbonate homopolymer (also referred to herein as bisphenol A polycarbonate). Preferably, the aromatic polycarbonate of the invention disclosed herein comprises at least 75 wt. %, preferably at least 95 wt. % of bisphenol A polycarbonate based on the total amount of aromatic polycarbonate. More preferably, the aromatic polycarbonate in the composition essentially consists or consists of bisphenol A polycarbonate. The aromatic polycarbonate according to the invention has a weight average molecular weight (Mw) in the range from 14.0 to 45.6 kg/mol, preferably in the range 17.7 to 38.9 kg/mol, more preferably in the range from 20.0 to 36.1 kg/mol as determined using gel permeation chromatography (GPC) with polystyrene standards. The aromatic polycarbonate preferably has a melt volume rate of from 4-30 cc/10 min as determined in accordance with ASTM D1238 (300° C., 1.2 kg).

In an aspect, the polycarbonate is an interfacial polycarbonate. In another aspect, the polycarbonate is a melt polycarbonate. In yet another aspect the polycarbonate is a mixture of from 20-80 wt. % or 40-60 wt. % of interfacial polycarbonate and from 80-20 wt. % or 60-40 wt. % of melt polycarbonate, based on the weight of the aromatic polycarbonate.

The aromatic polycarbonate according to the invention preferably comprises two or more aromatic polycarbonates having different weight average molecular weight. Preferably the aromatic polycarbonate according to the invention comprises two aromatic polycarbonates PC1 and PC2, wherein PC1 has a weight average molecular weight in the range from 14.2 to 26.1 kg/mol, preferably in the range from 18.3 to 23.8 kg/mol, more preferably in the range from 19.8 to 22.1 kg/mol as determined using GPC with polystyrene standards, wherein PC2 a weight average molecular weight in the range from 26.2 to 45.0 kg/mol, preferably in the range from 28.3 to 39.8 kg/mol, more preferably in the range from 29.8 to 34.1 kg/mol as determined using GPC with polystyrene standards. The amount ratio between PC1 and PC2 is preferably in the range from 0.5:1 to 7.5:1, preferably in the range from 0.5:1 to 6:1.

In the embodiments that the aromatic polycarbonate comprises two aromatic polycarbonates PC1 and PC2, the weight average molecular weight of the aromatic polycarbonate can be calculated using the following equation:

$${M}_{W ( P C )} = ( {M}_{W ( PC 1 )} ⋆ {φ}_{PC 1} + {M}_{{W ( PC 2 )}^{⋆}} {φ}_{PC 2} ) / ( {φ}_{PC 1} + {φ}_{PC 2} )$$

wherein M_{W(PC)} is the weight average molecular weight of the aromatic polycarbonate; M_{W(PC1)} is the weight average molecular weight of PC1; M_{W(PC2)} is the weight average molecular weight of PC2; φ_{PC1} is the weight fraction of PC1 based on the total weight of the thermoplastic composition; φ_{PC2} is the weight fraction of PC2 based on the total weight of the thermoplastic composition.

The same calculation applies to the embodiments that the aromatic polycarbonate comprises more than two aromatic polycarbonates.

In another aspect the aromatic polycarbonate comprises a polycarbonate copolymer comprising structural units of bisphenol A and structural units from another bisphenol.

### (B) Polyethylene Terephthalate

Polyethylene terephthalate (PET) is a well-known polyester and readily available. The polyethylene terephthalate may be a mixture of two or more different polyethylene terephthalates, for example a mixture of polyethylene terephthalates with mutually different molecular weights.

The polyethylene terephthalate may for example be a polyethylene terephthalate comprising polymeric units derived from ethylene glycol and terephthalic acid or an ester thereof such as dimethyl terephthalate. Preferably, the polyethylene terephthalate comprises polymeric units derived from ethylene glycol and terephthalic acid or an ester thereof such as dimethyl terephthalate.

The polyethylene terephthalate has an intrinsic viscosity in the range from 0.50 to 1.21 dl/g, preferably in the range from 0.71 to 1.08 dl/g, more preferably in the range from 0.75 to 0.96 dl/g as measured according to ASTM D2857-95 (2007)

The polyethylene terephthalate according to the invention can be obtained by interfacial polymerization or melt-process condensation, by solution phase condensation, or by transesterification polymerization wherein, for example, a dialkyl ester such as dimethyl terephthalate can be transesterified with ethylene glycol using acid catalysis, to generate polyethylene terephthalate. Alternatively, the polyethylene terephthalate according to the invention can be acquired by purchasing commercially available polyethylene terephthalate. In another embodiment, the polyethylene terephthalate is recycled material.

### (C) Poly(Butylene Terephthalate)

The poly(butylene terephthalate) (PBT) according to the invention may for example be a polymer comprising polymeric units derived from terephthalic acid or a diester thereof such as dimethyl terephthalate, and polymeric units derived from a butane-diol, such as 1,4-butanediol.

The PBT may further comprise polymeric units derived from other monomers, such as in particular isophthalic acid. For example, the PBT may comprise up to 10.0 wt. % of polymeric units derived from isophthalic acid, based on the weight of the PBT. Preferably, the PBT comprises up to 5.0 wt. % of units derived from isophthalic acid, such as from 1.0-4.0 wt. %. Alternatively, the PBT may be free of monomeric units other than units derived from butane-diol and terephthalic acid or a diester thereof. In other words, the PBT may be free from isophthalic acid.

The PBT may be a single polymer or may be a combination of 2 or more, preferably 2, PBT's having mutually different properties. For example, the PBT may comprise a first PBT and a second PBT each having a different weight average molecular weight. The PBT in the composition of the invention may accordingly be a blend of such a first and second (or further) PBTs.

In the embodiments that PBT comprises two PBTs: PBT1 and PBT2, the weight average molecular weight of the PBT can be calculated using the following equation:

$${M}_{W ( P B T )} = ( {M}_{W ( PBT 1 )} ⋆ {φ}_{PBT 1} + {M}_{W ( PBT 2 )} ⋆ {φ}_{PBT 2} ) / ( {φ}_{PBT 1} + {φ}_{PBT 2} )$$

wherein M_{W(PBT)} is the weight average molecular weight of the aromatic polycarbonate; M_{W(PBT1)} is the weight average molecular weight of PBT1; M_{W(PBT2)} is the weight average molecular weight of PBT2; φ_{PBT1} is the weight fraction of PBT1 based on the total weight of the thermoplastic composition; φ_{PBT2} is the weight fraction of PBT2 based on the total weight of the thermoplastic composition.

The same calculation applies to the embodiments that the PBT comprises more than two PBTs.

The PBT according to the invention has a weight average molecular weight in the range from 45.0 to 150.0 kg/mol, preferably in the range from 58.1 to 135.2 kg/mol, more preferably in the range from 64.2 to 125.3 kg/mol as measured with GPC using polystyrene standard.

The PBT may have a carboxylic end group content of from 10-80 mmol/kg, preferably from 20-60 mmol/kg, more preferably 20-40 mmol/kg as determined in accordance with ASTM D7409-15.

### (D) Impact Modifier

The thermoplastic composition of the invention comprises an impact modifier. The impact modifier is selected from the group consisting of acrylonitrile styrene butadiene copolymer, ethylene acrylate copolymer, ethylene acrylate glycidyl copolymer and mixtures thereof.

Preferably the impact modifier has a mean particle size in the range from 152 to 627 nm, preferably in the range from 226 to 445 nm, more preferably in the range from 256 to 397 nm, more preferably in the range from 272 to 335 nm, wherein the mean particle size is calculated by the particle size of 10000 particles obtained by TEM.

Preferably the impact modifier is an acrylonitrile-styrene-butadiene (ABS) copolymer. It was found thermoplastic composition comprising ABS shows improved flowability and impact performance than other commonly used impact modifier e.g., methyl-methacrylate butadiene-styrene core shell impact modifier (MBS).

Preferably the acrylonitrile-styrene-butadiene has an acrylonitrile content in the range from 8.3 to 19.8 wt. %, preferably in the range from 10.2 to 14.7 wt. %, a butadiene content of 27.5 to 73.2 wt. %, preferably in the range from 38.2 to 61.7 wt. %, more preferably in the range from 44.2 to 54.6 wt. % and a styrene content in the range from 23.4 to 46.8 wt. %, preferably in the range from 32.1 to 42.0 wt. % based on the total weight of the acrylonitrile-butadiene-styrene copolymer. It was found that the butadiene content in the preferred range leads to optimal balance between impact performance and stiffness.

### (E) Styrene Acrylonitrile Copolymer (SAN)

Preferably the thermoplastic composition according to the invention comprises styrene acrylonitrile copolymer.

SAN according to the invention preferably has an acrylonitrile level in the range from 12 to 56 wt. %, preferably in the range from 18 to 31 wt. %, more preferably in the range from 19 to 29 wt. % based on the total weight of the styrene acrylonitrile copolymer. It was found acrylonitrile level in the preferred range leads to improved compatibility between SAN and PC.

Preferably SAN according to the invention has an MFR in the range from 8 to 30 g/10 min, preferably in the range from 9 to 23 g/10 min, more preferably in the range from 10 to 18 g/10 min as determined according to ASTM D1238 at 230° C./1.2 kg. It was found the thermoplastic composition comprising SAN in the preferred MFI range presents an optimal flow/impact property balance.

### (F) Optional Additives

Optionally the thermoplastic composition according to the invention comprises additives. Typical additives include but are not limited to filler, reinforcing agent (e.g., glass fibers or glass flakes), antioxidant, heat stabilizer, light stabilizer, UV light stabilizer and/or UV absorbing additive, plasticizer, lubricant, release agent, in particular glycerol monostearate, pentaerythritol tetra stearate, glycerol tristearate, stearyl stearate, antistatic agent, antifog agent, antimicrobial agent, colorant (e.g., a dye or pigment), etc. (A) aromatic polycarbonate, (B) polyethylene terephthalate, (C) poly(butylene terephthalate), (D) impact modifier and (E) styrene acrylonitrile copolymer are not additives.

### Thermoplastic Composition

The thermoplastic composition comprises:
(A) from 30 to 59 wt. %, preferably from 30 to 56 wt. %, more preferably from 33 to 52 wt. % aromatic polycarbonate;
(B) from 20 to 40 wt. %, preferably from 25 to 35 wt. % polyethylene terephthalate;
(C) from 2 to 25 wt. %, preferably from 8 to 16 wt. % poly(butylene terephthalate); and
(D) from 10 to 20 wt. %, preferably from 12 to 16 wt. % impact modifier.
   wherein wt. % is based on the total weight of the thermoplastic composition.

It was found the thermoplastic composition comprising the preferred amount of (A) (B) (C) and (D) has improved flow/impact balance.

Preferably the thermoplastic composition according to the invention comprises 0 to 5 wt. % (E) styrene acrylonitrile copolymer (SAN) as flow modifier to improve the flowability of the thermoplastic composition. Preferably the thermoplastic composition comprises from 1.7 to 5.0 wt. %, preferable from 2.1 to 4.9 wt. % SAN. It was found the thermoplastic composition comprising SAN in the preferred amount range presents an optimal flow/impact property balance.

Optional the thermoplastic composition according to the invention comprises 0 to 3 wt. %, preferably 0 to 1.5 wt. % (F) additives.

Preferably the thermoplastic composition according to any one of the previous claims, wherein the following inequation is satisfied:

$${M}_{W ( PC )} + {M}_{W ( poly ( butylene terephthalate ) )} ⋆ exp ( 0.01 / {φ}_{poly ( butylene terephthalate )} ) \geq 101.5 kg / mol$$

More preferably, M_{W(PC)}+M_{W(poly(butylene terephthalate)}*exp(0.01/φ_{poly(butylene terephthalate)})≥102.5 kg/mol wherein M_{W(PC)} is the weight average molecular weight of the aromatic polycarbonate, M_{W(poly(butylene terephthalate)} is the weight average molecular weight of polyester poly(butylene terephthalate), φ_{poly(butylene terephthalate)} is the weight fraction of poly(butylene terephthalate) based on the total weight of the thermoplastic composition, wherein the weight average molecular weight is measured with GPC using polystyrene standard. It was found the thermoplastic composition satisfying the inequation has improved impact performance.

In the embodiments that the aromatic polycarbonate comprises two or more aromatic polycarbonates, e.g., two aromatic polycarbonates PC1 and PC2, the weight average molecular weight of the aromatic polycarbonate can be calculated using the following equation:

$${M}_{W ( P C )} = ( {M}_{W ( PC 1 )} ⋆ {φ}_{PC 1} + {M}_{W ( PC 2 )} ⋆ {φ}_{PC 2} ) / ( {φ}_{PC 1} + {φ}_{PC 2} )$$

wherein M_{W(PC)} is the weight average molecular weight of the aromatic polycarbonate; M_{W(PC1)} is the weight average molecular weight of PC1; M_{W(PC2)} is the weight average molecular weight of PC2; φ_{PC1} is the weight fraction of PC1 based on the total weight of the thermoplastic composition; φ_{PC2} is the weight fraction of PC2 based on the total weight of the thermoplastic composition. The same calculation applies to the embodiments that PBT comprises two or more PBTs.

Preferably the thermoplastic composition according to the invention has one or more—or is selected to have one or more—of the following properties:
a Spiral flow of at least 44.0 cm preferably at least 45.0 cm as measured according to with ASTM D-3123 09 (2017) with 3 mm thickness;
an Izod notched impact strength at 0° C. of at least 30 kJ/m2, preferably at least 50 kJ/m2 as measured according to ISO 180/1A;
an Izod notched impact strength at −10° C. of at least 24 kJ/m2, preferably at least 30 kJ/m2 as measured according to ISO 180/1A;
a tensile modulus of at least 1900 MPa, preferably at least 1950 MPa, more preferably at least 2000 MPa as measured according to ISO 527 at a temperature of 23° C.

Preferably, the total amount of (A) aromatic polycarbonate, (B) polyethylene terephthalate, (C) poly(butylene terephthalate), (D) impact modifier and (E) styrene acrylonitrile copolymer is at least 98 wt. % and not more than 100 wt. % based on the total weight of the thermoplastic composition.

(A) Aromatic polycarbonate, (B) polyethylene terephthalate, (C) poly(butylene terephthalate), (D) impact modifier, (E) styrene acrylonitrile copolymer and (F) additives can be referred as components of the thermoplastic composition according to the invention.

The thermoplastic composition can be manufactured by various methods known in the art. For example, (A) aromatic polycarbonate, (B) polyethylene terephthalate, (C) poly(butylene terephthalate), (D) impact modifier and (E) styrene acrylonitrile copolymer are first blended, optionally with any (F) additives, in a high speed mixer or by hand mixing. The blend is then fed into the throat of a twin-screw extruder via a hopper. Thermoplastic compositions described herein were typically extruded on a WP 25 millimeter (mm) co-rotating intermeshing twin-screw extruder having L/D of 41. Alternatively, at least one of the components can be incorporated into the composition by feeding it directly into the extruder at the throat and/or downstream through a side feeder, or by being compounded into a masterbatch with a desired polymer and fed into the extruder. The extruder is generally operated at a temperature higher than that necessary to cause the thermoplastic composition to flow. In a typical experiment, the extruder was set with barrel temperatures between 150° C. and 260° C. The material was run maintaining torque of 55-60% with a vacuum of 100 millibar (mbar)-800 mbar applied to the melt during compounding. The extrudate can be immediately cooled in a water bath and pelletized. The pellets so prepared can be one-fourth inch long or less as desired. Such pellets can be used for subsequent molding, shaping, or forming.

The present invention also relates to an article comprising the thermoplastic composition according to the invention, wherein the article is preferably an automotive external trim part, more preferably a heavy truck external trim part, e.g. wheel covers, side panels, air deflectors, front & lower grills, center & corner bumper, step/step panel, mud guards, cladding, lateral skirts, battery cover. Preferably the article comprises at least 90 wt. %, preferably at least 95 wt. %, more preferably at least 98 wt. %, most preferably 100 wt. % of the thermoplastic composition. The article can for example be prepared by injection molding, extrusion, blow molding and thermoforming.

In the context of the present invention the terms “amount” and “weight” have the same meaning, both refer to the quantity in mass of the components in the thermoplastic composition.

### Experiment

### Materials

| | |
|---|---|
| PC2 | Bisphenol A polycarbonate manufactured using an interfacial |
| (PC105) | process, having a melt volume rate of 6 cc/10 min in |
| | accordance with ASTM D1238 (300° C., 1.2 kg) and an Mw |
| | of 30.5 kg/mol available from SABIC. |
| PC1 | Bisphenol A polycarbonate manufactured using an interfacial |
| (PC175) | process, having a weight average molecular weight of about |
| | 22,000 g/mol and a melt volume rate of 26 cc/10 min in |
| | accordance with ASTM D1238 (300° C., 1.2 kg) and an Mw |
| | of 21.8 kg/mol available from SABIC. |
| PBT1 | Poly(butylene terephthalate) having an Mw of 120 kg/mol, |
| | available from SABIC as Valox ™ M 315 |
| PBT2 | Poly (butylene terephthalate) having an Mw of 70 kg/mol, |
| | available from SABIC as Valox ™ 195 |
| PET | Polyethylene terephthalate available from Indorama under |
| | trade name Ramapet, having an IV of 0.84 dl/g |
| ABS | ABS (acrylonitrile-butadiene-styrene copolymer) Impact |
| | modifier having an MFR of 11.5 g/10 min as measured |
| | according to ASTM D1238 at 220° C., 10 kg available from |
| | SABIC as Cycolac G360. This ABS is an ABS according to |
| | the invention |
| MBS | Methacrylate-butadiene-styrene copolymer core shell impact |
| | modifier having a polybutadiene content of 80 wt. %, |
| | commercially available from Dow as Paraloid MBS EXL |
| | 2650J |
| SAN | Styrene acrylonitrile copolymer available from SABIC, having |
| | an MFR of 12 g/10 min at 230° C./1.2 kg according to ASTM |
| | D1238 and an acrylonitrile level of 24% |
| MZP | Mono Zinc Phosphate, used as a quencher and commercially |
| | available from Budenheim as Budit T-21. |
| TBPP | tris(2,4-di-tert-butylphenyl)phosphite, commercially available |
| | as Irgafos 168 |
| AO | octadecyl-3-[3,5-di-tert-butyl-4-hydroxyphenyl]propionate, |
| | available from BASF as Irganox 1076 |
| PETS | Pentaerythritol Tetrastearate from Faci as PETS G |
| Talc | Jetfine 3CA from Imerys |
| Additive | Consisting of 40 wt. % PETS, 7 wt. % MZP, 13 wt. % TBPP, |
| package | 13 wt. % AO, 27 wt. % Talc based on the total weight of the |
| | additive package |

### Example Preparation, Measurement Methods and Eq 1

All Examples were obtained from a compounding process on a 25 mm co-rotating intermeshing twin-screw extruder having L/D of 41. The ingredients of each example were added at the feed throat of the extruder. The extruder was set with barrel temperatures between 150° C. and 260° C. The material was run maintaining torque of 55-60% with a vacuum of 100 millibar (mbar)-800 mbar applied to the melt during compounding. Examples were molded on an Engel 75T molding machine for further testing. Ex. refers to Examples according to the invention, CE. refers to comparative examples.

| | |
|---|---|
| Impact | Izod Notched Impact was determined in accordance with ISO |
| (INI) | 180/1A measured on injection moulded specimens having |
| | dimensions of 80 × 10.0 × 4.0 mm. INI was carried out at 23° C., |
| | 0° C. and −10° C. |
| Intrinsic | The intrinsic viscosity was determined in accordance with ASTM |
| viscosity | D2857-95 (2007), the solvent was 1:1 weight to weight mixture |
| | of phenol:1,1,2,2 - tetrachloro ethane at 30° C. |
| Molecular | The weight average molecular weight of the PC and PBT was |
| weight | measured with GPC method using polystyrene standard in an |
| | Agilent 1200 system equipped with PL HFIPgel column and |
| | Refractive Index detector. The sample is dissolved in 10% HFIP |
| | solution in chloroform and the same solvent is used as carrier. |
| Eq 1 | M_{W(PC)} + M_{W(PBT)}*exp(0.01/φ_{PBT}) wherein M_{W(PC)} is the weight |
| | average molecular weight of PC, M_{W(PBT)} is the weight average |
| | molecular weight of PBT, φ_{PBT} is the weight fraction of PBT. If |
| | there is more than one PC in the composition, M_{W(PC)} is |
| | calculated as (M_{W(PC1)}*φ_{PC1} + M_{W}(_{PC2})*φ_{PC2})/(φ_{PC1} + φ_{PC2}). |
| | Same applies to PET. |
| Tensile | Tensile modulus was determined in accordance with ISO 527 at |
| modulus | a temperature of 23° C. measured on injection moulded |
| | specimens having dimensions of 170 × 10.0 × 4.0 mm. |
| Spiral | Spiral flow was determined in accordance with ASTM D-3123 |
| flow | 09 (2017) under the following conditions: 3 mm, T zone 1-2-3: |
| | 255-265-275° C., T mold 60° C., 182 bar in an Engel 75T |
| | molding machine. |

### Result

The composition of examples along with their properties are presented in the tables below.

TABLE 1
Composition and performance of Examples 1 to 8.

| | | CE. 1 | Ex. 2 | Ex. 3 | CE. 4 | CE. 5 | CE. 6 | CE. 7 | Ex. 8 |
|---|---|---|---|---|---|---|---|---|---|
| PC 1 | % | 39.25 | 39.25 | 39.25 | 39.25 | 39.25 | 57.39 | 67.39 | 57.39 |
| PET | % | 40 | 30 | 20 | 10 | — | 30 | 20 | 20 |
| PBT 1 | % | — | 10 | 20 | 30 | 40 | — | — | 10 |
| ABS | % | 20 | 20 | 20 | 20 | 20 | 12 | 12 | 12 |
| Additives | % | 0.75 | 0.75 | 0.75 | 0.75 | 0.75 | 0.61 | 0.61 | 0.61 |
| Result Eq 1 | kg/mol | | 154.4 | 148.0 | 145.9 | 144.8 | | | 154.4 |
| Spiral Flow | cm | 58.8 | 52.8 | 48.8 | 46.2 | 45.4 | 47.0 | 45.0 | 44.7 |
| INI at 23° C. | kJ/m2 | 21.8 | 55.6 | 56.0 | 54.1 | 56.5 | 61.0 | 59.0 | 61.0 |
| INI at 0° C. | kJ/m2 | 17.1 | 38.2 | 41.5 | 35.8 | 41.4 | 38.0 | 53.0 | 56.0 |
| INI T −10° C. | kJ/m2 | 17.1 | 35.1 | 29.2 | 25.3 | 24.9 | 32.4 | 37.5 | 53.1 |
| Ten. Mod.* | GPa | 1886 | 1944 | 1986 | 1999 | 1990 | 2080 | 2080 | 2120 |

*Ten. Mod. = Tensile Modulus

Examples 1 to 5 are comparable with each other, among these Examples, only Ex2, 3 (containing both PBT and PET in an amount according to the invention) demonstrate optimal balance between Spiral flow, INI and Tensile modulus. By comparison between Examples 6 to 8, it is clear that only Ex. 8 containing both PBT and PET shows superior INI at −10° C.

TABLE 2
Composition and performance of Example 9 to 12.

| | | Ex. 9 | Ex. 10 | Ex. 11 | CE. 12 |
|---|---|---|---|---|---|
| PC 1 | % | 47.25 | 43.25 | 39.25 | 35.25 |
| PET | % | 30 | 30 | 30 | 30 |
| PBT 1 | % | 10 | 10 | 10 | 10 |
| ABS | % | 12 | 16 | 20 | 24 |
| Additives | % | 0.75 | 0.75 | 0.75 | 0.75 |
| Result of Eq 1 | kg/mol | 154.4 | 154.4 | 154.4 | 154.4 |
| Spiral Flow | cm | 50.4 | 51.3 | 52.8 | 54.2 |
| INI at 23° C. | kJ/m2 | 55.0 | 56.3 | 55.6 | 55.9 |
| INI at 0° C. | kJ/m2 | 35.6 | 38.6 | 38.2 | 40.4 |
| INI T −10° C. | kJ/m2 | 24.5 | 33.0 | 35.1 | 27.8 |
| Tensile modulus | GPa | 2111 | 2036 | 1944 | 1842 |

According to Table 2 a too high amount of ABS leads to unsatisfactory Tensile modulus.

TABLE 3
Composition and performance of Example 13 to 16.

| | | CE. 15 | CE. 16 | CE. 13 | CE. 14 |
|---|---|---|---|---|---|
| PC 1 | % | 49.25 | 45.25 | 61.39 | 57.39 |
| PET | % | 30 | 30 | 30 | 30 |
| PBT 1 | % | 10 | 10 | — | — |
| MBS | % | 10 | 14 | 8 | 8 |
| SAN | % | | | | 4 |
| Additives | % | 0.75 | 0.75 | 0.61 | 0.61 |
| Spiral Flow | cm | 49.4 | 51.2 | 36.2 | 40.0 |
| INI at 23° C. | kJ/m2 | 41.1 | 41.5 | 57.1 | 61.6 |
| INI at 0° C. | kJ/m2 | 35.7 | 36.8 | 51.2 | 45.1 |
| INI T −10° C. | kJ/m2 | 24.8 | 33.4 | 40.0 | 26.9 |
| Tensile modulus | GPa | 2106 | 1998 | 2080 | 2110 |

According to Table 3, MBS is not as effective as ABS as an impact modifier since MBS leads inferior Spiral flow (CE. 13, 14) or inferior INI at 23° C. (CE. 15, 16).

TABLE 4
Composition and performance of Example 17 to 25

| | | Ex. | Ex. | Ex. | Ex. | Ex. | Ex. | Ex. | Ex. | Ex. |
|---|---|---|---|---|---|---|---|---|---|---|
| | | 17 | 18 | 19 | 20 | 21 | 22 | 23 | 24 | 25 |
| PC 1 | % | 39.25 | 29.4375 | 19.625 | 34.25 | 34.25 | 19.625 | 37.25 | 37.25 | 32.25 |
| PC 2 | % | | 9.8125 | 19.625 | 5 | 5 | 19.625 | 5 | 5 | 5 |
| PET | % | 30 | 30 | 30 | 30 | 30 | 30 | 32 | 32 | 30 |
| PBT 1 | % | | | | 10 | | | 5 | | 12 |
| PBT 2 | % | 10 | 10 | 10 | | 10 | 10 | | 5 | |
| ABS | % | 20 | 20 | 20 | 20 | 20 | 20 | 20 | 20 | 20 |
| Additives | % | 0.75 | 0.75 | 0.75 | 0.75 | 0.75 | 0.75 | 0.75 | 0.75 | 0.75 |
| Result Eq 1 | kg/mol | 99.2 | 101.3 | 103.5 | 155.5 | 100.3 | 103.5 | 169.4 | 108.3 | 153.4 |
| Spiral Flow | cm | 59.4 | 57.2 | 54.5 | 48.8 | 59.0 | 56.8 | 53.0 | 54.2 | 50.0 |
| INI at 23° C. | kJ/m2 | 50.3 | 52.6 | 56.0 | 57.2 | 53.5 | 57.8 | 57.7 | 54.7 | 58.5 |
| INI at 0° C. | kJ/m2 | 23.6 | 25.1 | 34.6 | 52.9 | 29.1 | 31.0 | 50.2 | 31.3 | 36.6 |
| INI at −10° C. | kJ/m2 | 22.6 | 23.3 | 25.2 | 36.1 | 24.4 | 27.5 | 34.3 | 25.2 | 30.4 |
| Ten. Mod.* | GPa | 1967 | 1970 | 1981 | 1944 | 1961 | 1966 | 1913 | 1933 | 1967 |

*Ten. Mod. = Tensile Modulus

According to Table 4, the result of Eq 1 which is related to PC and PBT's molecular weight needs to be at least 101.5 kg/mol to achieve the improved INI at −10° C. (at least 30.0 kJ/m2).

TABLE 5
Composition and performance of Example 26 to 28.

| | | Ex. 26 | Ex. 27 | Ex. 28 |
|---|---|---|---|---|
| PC 1 | % | 31.25 | 18.125 | 5 |
| PC 2 | % | 5 | 18.125 | 28.25 |
| PET | % | 30 | 30 | 30 |
| PBT 1 | % | 10 | 10 | 10 |
| ABS | % | 20 | 20 | 20 |
| SAN | % | 3 | 3 | 6 |
| Additives | % | 0.75 | 0.75 | 0.75 |
| Result of Eq 1 | kg/mol | 155.6 | 158.8 | 161.8 |
| Spiral Flow | cm | 57.4 | 58.1 | 60.1 |
| INI at 23° C. | kJ/m2 | 56.6 | 58.0 | 53.0 |
| INI at 0° C. | kJ/m2 | 36.7 | 51.0 | 29.9 |
| INI at −10° C. | kJ/m2 | 27.1 | 29.4 | 23.6 |
| Tensile modulus | GPa | 1990 | 1994 | 2044 |

According to Table 5, using SAN as flow modifier can result in better spiral flow performance, but a too high amount of SAN leads to a too low INI at −10° C.

1. A thermoplastic composition comprising:
(A) from 30 to 59 wt. % aromatic polycarbonate, wherein the aromatic polycarbonate has a weight average molecular weight in the range from 14.0 to 45.6 kg/mol as measured with gel permeation chromatography (GPC) using polystyrene standard;
(B) from 20 to 40 wt. % polyethylene terephthalate, wherein the polyethylene terephthalate has an intrinsic viscosity in the range from 0.50 to 1.21 dl/g as measured according to ASTM D2857-95 (2007);
(C) from 2 to 25 wt. % poly(butylene terephthalate), wherein the poly(butylene terephthalate) has a weight average molecular weight in the range from 45.0 to 150.0 kg/mol as measured with gel permeation chromatography (GPC) using polystyrene standard;
(D) from 10 to 20 wt. % impact modifier having a fraction in the range, wherein the impact modifier is selected from the group consisting of acrylonitrile styrene butadiene copolymer, ethylene acrylate copolymer, ethylene acrylate glycidyl copolymer and mixtures thereof;
wherein wt. % is based on the total weight of the thermoplastic composition.

2. The thermoplastic composition according to claim 1, wherein thermoplastic composition comprises (E) from 0 to 5 wt. % styrene acrylonitrile copolymer.

3. The thermoplastic composition according to claim 2, wherein the (E) styrene acrylonitrile copolymer has an acrylonitrile level in the range from 12 to 56 wt. %, based on the total weight of the styrene acrylonitrile copolymer.

4. The thermoplastic composition according to claim 2, wherein the thermoplastic composition comprises from 1.7 to 5.0 wt. % (E) styrene acrylonitrile copolymer

5. The thermoplastic composition according to claim 2, wherein the (E) styrene acrylonitrile copolymer has an MFR in the range from 8 to 30 g/10 min, as determined according to ASTM D1238 at 230° C./1.2 kg.

6. The thermoplastic composition according to claim 1, wherein the following inequation is satisfied:
$${M}_{W ( P C )} + {M}_{W ( poly ( butylene terephthalate ) )} ⋆ exp ( 0 \text{.01} / {ϕ}_{poly ( b u t ylene terephthalate )} ) \geq 101.5 kg / mol$$
wherein M_{W(PC)} is the weight average molecular weight of the aromatic polycarbonate, M_{W(poly(butylene terephthalate)}) is the weight average molecular weight of polyester poly(butylene terephthalate), φ_{poly(butylene terephthalate)} is the weight fraction of poly(butylene terephthalate) based on the total weight of the thermoplastic composition, wherein the weight average molecular weight is measured with GPC using polystyrene standard.

7. The thermoplastic composition according to claim 1, wherein the (D) impact modifier has a mean particle size in the range from 152 to 627 nm.

8. The thermoplastic composition according to claim 1, wherein the (D) impact modifier is an acrylonitrile butadiene styrene copolymer

9. The thermoplastic composition according to claim 8, wherein the acrylonitrile butadiene styrene copolymer has an acrylonitrile content in the range from 8.3 to 19.8 wt. %, a butadiene content of 27.5 to 73.2 wt. %, and a styrene content of 23.4 to 46.8 wt. % based on the total weight of the acrylonitrile-butadiene-styrene copolymer.

10. The thermoplastic composition according to claim 1, wherein the (A) aromatic polycarbonate comprises two or more aromatic polycarbonates having different weight average molecular weight.

11. The thermoplastic composition according to claim 1, wherein (B) polyethylene terephthalate has an intrinsic viscosity in the range from 0.71 to 1.08 dl/g.

12. The thermoplastic composition according to claim 1, wherein the thermoplastic composition comprises from 30 to 56 wt. % (A) aromatic polycarbonate.

13. The thermoplastic composition according to claim 1, selected to have one or more of the following:
a Spiral flow of at least 44.0 cm as measured according to with ASTM D-3123 09 (2017) with 3 mm thickness;
an Izod notched impact strength at 0° C. of at least 30 kJ/m², as measured according to ISO 180/1A;
an Izod notched impact strength at −10° C. of at least 24 kJ/m², as measured according to ISO 180/1A;
a tensile modulus of at least 1900 MPa, as measured according to ISO 527 at a temperature of 23° C.

14. The thermoplastic composition according to claim 1, wherein the total amount of (A) aromatic polycarbonate, (B) polyethylene terephthalate, (C) poly(butylene terephthalate), (D) impact modifier and (E) styrene acrylonitrile copolymer is at least 98 wt. % and not more than 100 wt. % based on the total weight of the thermoplastic composition.

15. An article comprising the thermoplastic composition according to claim 1.
